(19) United States
(12) Patent Application Publication
(10) Pub. No.: US 2018/0087395 A1
(43) Pub. Date: Mar. 29, 2018

(54) GAS TURBINE ENGINE

(71) Applicant: ROLLS-ROYCE plc, London (GB)

(72) Inventor: Adrian L. HARDING, Derby (GB)

(73) Assignee: ROLLS-ROYCE plc, London (GB)

(21) Appl. No.: 15/714,082

(22) Filed: Sep. 25, 2017

(30) Foreign Application Priority Data
Sep. 23, 2016 (GB) 1616197.8

(51) Int. Cl. F01D 11/22; F01D 9/04; F01D 17/16; F01D 25/24

(52) U.S. Cl. CPC F01D 11/22; F01D 9/041; F05D 2260/50; F01D 25/24; F05D 2220/32; F01D 17/16

(57) ABSTRACT

A gas turbine engine comprising a rotor blade, an inner casing and an outer casing, a guide vane, located upstream of the rotor blade and between the inner and outer casing, the guide vane comprising a vane contact member, wherein the guide vane is configured to pivot upon axial displacement of the inner casing relative to either or both of the outer casing and the rotor blade; and, a seal segment located radially outwardly of the rotor blade and mounted for radial displacement relative to the rotor blade; wherein at least a portion of the seal segment axially overlaps, and slidably engages a downstream end of the guide vane so that a pivoting of the guide vane causes the vane contact member to undergo a radially outward displacement which causes a radially outward displacement of at least a portion of the seal segment.

### CROSS-REFERENCE TO RELATED APPLICATIONS

This specification is based upon and claims the benefit of priority from UK Patent Application Number 1616197.8 filed on 23 Sep. 2016, the entire contents of which are incorporated herein by reference.

### BACKGROUND

### Field of Disclosure

The present disclosure concerns a gas turbine engine comprising a seal segment arrangement.

### Description of the Related Art

Guide vanes are static aerofoils that direct working fluid towards the moving or rotating blades of a compressor or turbine stage of a gas turbine engine, with minimum loss of energy. In particular, guide vanes are formed of static aerofoil portions, provided upstream of a rotor stage to direct air onto the blades of the rotor stage. Inlet guide vanes (IGVs) are provided to direct air on to the blades of a compressor stage, whereas nozzle guide vanes (NGVs) are provided to direct air onto the blades of a turbine stage. In a pre-existing arrangement, a guide vane is fixed in position by securing members at radially inner and outer regions of the guide vane. In the case of the high pressure turbine of a three-shaft gas turbine engine, the NGV is held in position by securing members at two axial positions on the outer platform. NGVs known within the art are axially and radially fixed to an internal casing structure (also known as an inner casing) and additionally axially supported by an external casing (also known as an outer casing), either directly or via another structure, such as a blade track assembly or a seal segment support. The seal segment support holds a seal segment at a radially outer location relative to the radially outer tips of the rotating blades of the turbine stage, so defining a working gap therebetween. The working gap defines the degree of sealing provided by the particular seal segment. Under some conditions, the working gap may increase and/or decrease, so resulting in increased leakage or a rubbing of the seal segment by the rotating blades. To vary or control these effects, tip clearance control (TCC) mechanisms are employed.

Current Tip Clearance Control (TCC) mechanisms rely upon modifying the temperature of a casing, so as to control the radial position of the seal segment. In the case of NGVs in conjunction with sealing arrangements known within the art, rapid acceleration of the rotor during for example, ramp-up, take-off, climb or step-climb conditions, causes the rotor blade to deflect radially outwardly due to increased stress and/or temperature. This causes the rotor blade to close the working gap too quickly for the TCC to respond, so requiring one or more of a sufficient working gap to accommodate any movement and/or the incorporation of a rub-tolerant design; both of which result in increased weight, increased working gap and a less efficient engine. It has been found that radial deflection of the rotor blade results in excessive leakage of gases over the high pressure blade, hence reducing the performance of the engine. Furthermore, should the rotor blade rub against the seal segment, a scoring or rubbing of the seal segment will lead to an increased tip gap and further leakage, further reducing the performance of the engine and requiring further segment maintenance or replacement at engine service.

Some attempts have been made to produce a rapid change to the tip gap at take-off and step-climb events, such as the use of valves and ducting to pass hot air over/under the casing when the throttle is activated. Such methods invariably add substantial weight, cost and complexity to the engine.

It is an object of the present disclosure to provide a sealing arrangement which addresses one or more of the aforementioned disadvantages.

### SUMMARY

According to a first aspect there is provided a gas turbine engine for the provision of propulsive thrust, comprising a rotor blade, an inner casing and an outer casing, the gas turbine engine further comprising; a guide vane located upstream of the rotor blade and between the inner and outer casing, the guide vane comprising a vane contact member, wherein the guide vane is configured to pivot upon axial displacement of the inner casing relative to either or both of the outer casing and the rotor blade; and, a seal segment located radially outwardly of the rotor blade and mounted for radial displacement relative to the rotor blade; wherein at least a portion of the seal segment axially overlaps, and slidably engages a downstream end of the guide vane so that in use, a pivoting of the guide vane causes the vane contact member to undergo a radially outward displacement, the radially outward displacement of the vane contact member causing a radially outward displacement of at least a portion of the seal segment.

The arrangement provides that radially outward displacement of at least a portion of the seal segment relative to the rotor blade increases a gap therebetween when the vane contact member is displaced radially outwardly through a pivoting of the guide vane. The guide vane and vane contact member may be displaced in this way during a sudden increase in thrust which causes relative movement between two or more components to which the guide vane is engaged. This prevents detrimental contact between the rotor blade and the seal segment during one or more of acceleration, increased temperature, pressure, increased power or increased rate of change of power, which otherwise causes the rotor blade to extend radially outwards due to one or more of thermal expansion and centrifugal forces acting on the rotor blade. Such contact rubs the seal segment, so increasing the gap between the seal segment and the rotor blade during normal operating conditions.

Radial displacement of at least a portion of the seal segment may be temporary. External factors acting on the guide vane to cause displacement may diminish or reduce in intensity, so returning the guide vane and guide contact member to their initial position as the external support catches up. In this way, the arrangement may be mechanical and automatic, and although process control or further automation may be incorporated within the arrangement, it may not be required for operation of the described arrangement.

The arrangement provides that the gap between the rotor blade and the seal segment is better controlled during use, resulting in increased engine efficiency and reduced fuel consumption due to increased sealing efficiency.

The guide vane may be located radially inwardly of, and may be flexibly mounted to the outer casing. The outer casing may be annular.

By mounting the guide vane to the outer casing, the portion of the guide vane which is mounted to the outer casing is provided with added support and structural integrity relative to the external casing. Increasing the structural integrity of the guide vane in this way mitigates against deflection of the guide vane, in use, relative to the outer casing. By flexibly mounting the guide vane to the outer casing, a degree of movement of the guide vane relative to the outer casing may be permitted.

The guide vane may be located radially outwardly of, and may be flexibly mounted to the inner casing. The inner casing may be annular.

By mounting the guide vane to the inner casing, the portion of the guide vane which is mounted to the inner casing is provided with added support and structural integrity relative to the inner casing. Increasing the structural integrity of the guide vane in this way mitigates against deflection of the guide vane, in use, relative to the inner casing, but allows the guide vane to be displaced from its normal position as the inner casing is displaced. By flexibly mounting the guide vane to the inner casing, a degree of movement of the guide vane relative to the inner casing may be permitted.

Through the combination of guide vane mountings to both the inner and outer casing, the permitted deflection of the guide vane, in use, is limited to that of one or more of the inner and outer casing.

As the arrangement may be mounted to an inner casing defining an annulus within the gas turbine engine, the arrangement provides the further advantage that the seal segment may be used as part of an annular array of two or more such arrangements within the gas turbine engine.

The guide vane may comprise one or more vane contact members which axially extend from a portion of the guide vane, the guide vane extending radially outwardly of an aerofoil portion.

The guide vane contact members provide one or more guide vane contact areas located at the downstream end of the guide vane to engage with at least a portion of the seal segment. The guide vane contact members may extend from a portion of the guide vane which is radially outwardly of an aerofoil portion to maintain efficient flow of the working fluid over the aerofoil. Such areas may include a portion of a radially outer platform or tip of the guide vane, or further areas of the guide vane which are separated from the main body of the working fluid, in use, flowing over the aerofoil.

The seal segment may comprise one or more seal segment contact members which axially extend from a portion of the seal segment, the one or more seal segment contact members extending radially outwardly of a sealing face of the seal segment.

The seal segment contact members provide one or more seal segment contact areas located at the upstream end of the seal segment to engage with at least a portion of the guide vane. The seal segment contact members may extend from a portion of the seal segment which is radially outwardly of a sealing face to maintain efficient flow of the working fluid between the sealing face of the seal segment and the rotor blade. Such areas may alternatively include any further portion of the radially extending portion or tip of the seal segment, or further areas of the seal segment which are separated from the main body of the working fluid, in use, flowing between the seal segment and the rotor blade.

Multiple contact members may also be used on one or more of the guide vane and the seal segment. Such arrangements improve the reliability of the arrangement when contacting one or more further components by providing an increased number of contact points to prevent failure of the arrangement should any one contact point fail. An increased number of contact points provide the additional capability to contact or support larger, heavier components due to an increased contact area, and hence a reduced operational stress of any one contact member.

Furthermore, the slidable engagement between the axially extending and overlapping contact members allows the seal segment to maintain contact with the guide vane over a range of relative positions. Hence, contact members of variable lengths and overlap may increase the distance or permitted range of movement between the seal segment and the guide vane, whilst maintaining contact therebetween. Tailored degrees of overlap of the one or more seal segments relative to the one or more contact members may also improve contact reliability between the seal segment and the guide vane over a wider range of movements.

The seal segment may be either or both of axially and circumferentially constrained relative to the outer casing. Additionally or alternatively, the seal segment may be located radially inwardly of, and may be either or both of axially and radially constrained relative to the outer casing.

By one or more of axially, circumferentially, or radially constraining at least a portion of the seal segment relative to the outer casing, the seal segment is provided with added support and structural integrity from the structurally resilient external casing. Increasing the structural integrity of the seal segment in this way may allow radial displacement of one or more portions of the seal segment, but may mitigate against axial or lateral deflection of the seal segment relative to the inherently resilient outer casing.

The seal segment may be spaced from, and mounted to the outer casing via a seal segment support.

The seal segment may be indirectly engaged with the outer casing via one or more seal segment supports. The seal segment supports allow the seal segment to be located at one or more locations radially inwardly of the outer casing, whilst allowing radial displacement of one or more portions of the seal segment but mitigates against axial or lateral deflection of the seal segment relative to the inherently resilient outer casing.

The guide vane may be flexibly mounted to the seal segment support to allow the guide vane to pivot relative to the outer casing upon axial displacement of the inner casing relative to the outer casing.

By flexibly engaging the guide vane to the outer casing via the seal segment support, the guide vane is provided with added support and structural integrity from the structurally resilient external casing. Providing a flexible engagement between the guide vane and the seal segment support allows the guide vane to flexibly pivot relative to one or more of the outer casing, seal segment and seal segment support upon axial displacement of the inner casing relative to the outer casing. Hence, the flexible engagement between the guide vane and the seal segment support also mitigates against lateral deflection of the guide vane relative to the inherently resilient outer casing.

Providing support to the guide vane via the seal segment support also reduces weight and eliminates the requirement to provide a further weld or attachment means to the external casing for the sole purpose of supporting, or providing a means to support to the guide vane.

The guide vane may be flexibly mounted to the outer casing and inner casing to allow the guide vane to pivot relative to the outer casing upon axial displacement of the inner casing relative to the outer casing.

By flexibly engaging the guide vane to the outer casing and inner casing, the guide vane is provided with added support and structural integrity directly from the structurally resilient external casing. Providing a flexible engagement between the guide vane and the outer casing allows the guide vane to flexibly pivot relative to one or more of the outer casing, seal segment and seal segment support upon axial displacement of the inner casing relative to the outer casing. Hence, the flexible engagement between the guide vane and the outer casing mitigates against lateral deflection of the guide vane relative to the inherently resilient outer casing. The flexible engagement between the guide vane and the inner casing mitigates against lateral deflection of the guide vane relative to the inner casing whilst allowing the guide vane to pivot.

Providing support to the guide vane via the outer casing reduces the complexity of the seal segment support and can increase reliability of the arrangement by reducing the mechanical loading on any one particular engagement to the outer casing.

The seal segment may be slidably engaged with the seal segment support to permit radial displacement of one or more portions of the seal segment relative to the seal segment support.

The seal segment may be slidably engaged to, and slide relative to the seal segment support during use. Such a range of movement allows displacement of the entire seal segment, or one or more portions of the seal segment support, so providing at least a tilting effect of the seal segment via slidable engagement with, and radial displacement of the guide vane.

The seal segment support may be slidably engaged with the outer casing to permit radial displacement of one or more portions of the seal segment support relative to the outer casing. The seal segment may be fixedly coupled to the seal segment support. The seal segment support may be slidably engaged to, and slide relative to the outer casing during use. Such a range of movement allows displacement of the entire seal segment support, or one or more portions of the seal segment support, so providing at least a tilting effect of the seal segment support via slidable engagement with, and radial displacement of the guide vane.

In this way, displacement of at least a portion of the seal segment support allows displacement of the entire seal segment, or for one or more portions of the seal segment to undergo a tilting effect via slidable engagement with, and radial displacement of the guide vane.

In this way, an axial deflection of the inner casing may provide a pivoting of the guide vane. Such an action may, in turn, provide at least a radially outward displacement of at least a portion of the guide vane. The radially outward displacement of the guide vane causes the guide vane to contact the seal segment at the upstream end of the seal segment. A radially outward displacement of the seal segment at the upstream end of the seal segment subsequently causes at least a portion of the seal segment to pivot, so increasing the spacing between the seal segment and the rotor blade.

The skilled person will appreciate that except where mutually exclusive, a feature described in relation to any one of the above aspects may be applied mutatis mutandis to any other aspect. Furthermore except where mutually exclusive any feature described herein may be applied to any aspect and/or combined with any other feature described herein.

### BRIEF DESCRIPTION OF THE DRAWINGS

Embodiments will now be described by way of example only, with reference to the Figures, in which:

FIG. 1 is a sectional side view of a gas turbine engine;

FIG. 2 is a sectional side view of a conventional sealing arrangement;

FIG. 3 is a sectional side view of a sealing arrangement without an applied load;

FIG. 4 is a sectional side view of a sealing arrangement with an applied axial load;

FIG. 5 is a sectional side view of a further example of a sealing arrangement without an applied load; and,

FIG. 6 is a sectional side view of a further example of a sealing arrangement without an applied load.

### DETAILED DESCRIPTION OF THE DISCLOSURE

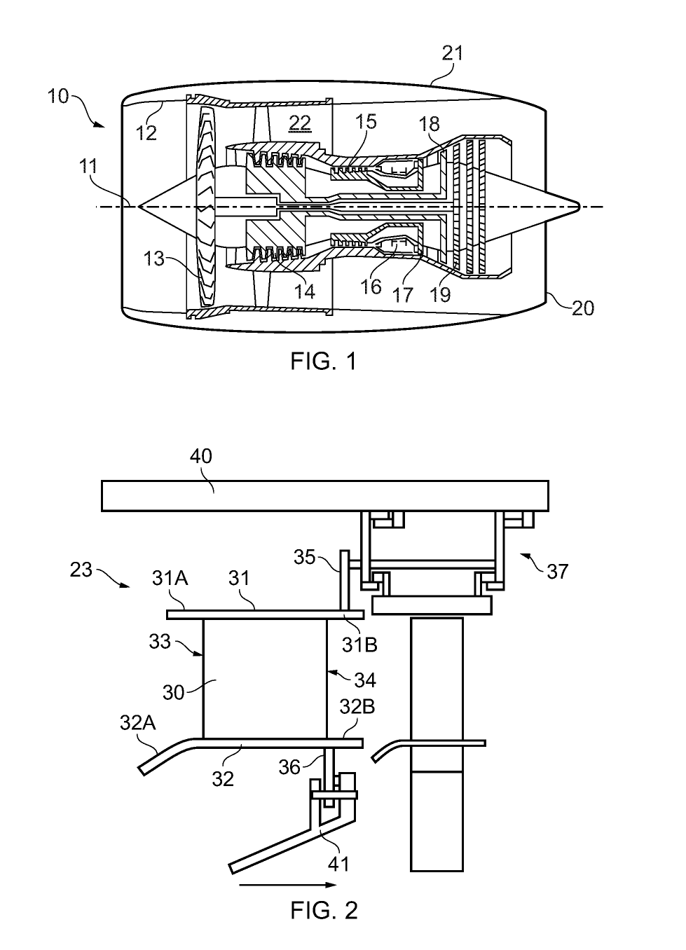

With reference to FIG. 1, a gas turbine engine is generally indicated at 10, having a principal and rotational axis 11. The engine 10 comprises, in axial flow series, an air intake 12, a propulsive fan 13, an intermediate pressure compressor 14, a high-pressure compressor 15, combustion equipment 16, a high-pressure turbine 17, an intermediate pressure turbine 18, a low-pressure turbine 19 and an exhaust nozzle 20. A nacelle 21 generally surrounds the engine 10 and defines both the intake 12 and the exhaust nozzle 20.

The gas turbine engine 10 works in the conventional manner so that air entering the intake 12 is accelerated by the fan 13 to produce two air flows: a first air flow into the intermediate pressure compressor 14 and a second air flow which passes through a bypass duct 22 to provide propulsive thrust. The intermediate pressure compressor 14 compresses the air flow directed into it before delivering that air to the high pressure compressor 15 where further compression takes place.

The compressed air exhausted from the high-pressure compressor 15 is directed into the combustion equipment 16 where it is mixed with fuel and the mixture combusted. The resultant hot combustion products then expand through, and thereby drive the high, intermediate and low-pressure turbines 17, 18, 19 before being exhausted through the nozzle 20 to provide additional propulsive thrust. The high 17, intermediate 18 and low 19 pressure turbines drive respectively the high pressure compressor 15, intermediate pressure compressor 14 and fan 13, each by suitable interconnecting shaft.

Other gas turbine engines to which the present disclosure may be applied may have alternative configurations. By way of example such engines may have an alternative number of interconnecting shafts (e.g. two) and/or an alternative number of compressors and/or turbines. Further the engine may comprise a gearbox provided in the drive train from a turbine to a compressor and/or fan.

FIG. 2 shows a guide vane member 23 for association within a guide vane arrangement as known within the art. As can be seen, the vane member 23 comprises an aerofoil 30 with an outer platform 31 and an inner platform 32. The outer platform 31 includes a platform portion 31A which extends forwards of a leading edge 33 of the vane aerofoil 30, and a platform portion 31B which extends rearwards of a trailing edge 34 of the vane aerofoil 30. The inner platform 32 includes a platform portion 32A which extends forwards of a leading edge 33 of the vane aerofoil 30, and a platform portion 32B which extends rearwards of a trailing edge 34 of the vane aerofoil 30.

The vane member 23 is secured through one or more outer securing members 35 to a static seal segment support assembly 37, which is itself secured to an outer casing 40, which defines an annulus as part of the gas turbine engine about an axis of rotation, so securing the vane member 23 to the outer casing 40. The one or more outer securing members 35 extend radially outwardly from platform portion 31B towards, and engage with the statically arranged seal segment support assembly 37 in order to support the vane member 23 relative to the outer casing 40 and provide ease of manufacture.

The vane member 23 is further secured through one or more inner securing members 36, or via a further attachment assembly (not shown), to a radially inner casing 41 which defines an annulus within the gas turbine engine about an axis of rotation. The one or more inner securing members 36 extend radially inwardly from platform portion 32B towards, and engage with the inner casing 41 in order to support the vane member 23 relative to the outer casing 40 and provide ease of manufacture. It will be understood that the securing members 36 engage as indicated parts of the vane member 23 to support the vane member 23 in use, relative to the inner casing 41.

During one or more of acceleration, increased temperature, pressure, increased power or increased rate of change of power, the inner casing moves axially downstream of the gas turbine engine. This results in differential axial movement of the inner casing 41 relative to the outer casing 40. Whilst the guide vane 23 is attached to both the inner 41 and outer 40 casings, the inner casing 41 is typically thinner and more flexible than the outer 40 casing. As such, the thinner sections used make the inner casing 41 are more prone to rapid changes in temperature and associated deflections resulting from thermally applied stresses, thermal expansions and applied loads. Due to the quicker reaction of inner casing to increased temperatures and pressures than the outer casing, the inner casing 41 readily deflects before the outer casing. The difference in deflection rate causes the inner casing 41, guide vane 23 and attachments to be axially displaced relative to the outer casing 40. Due to movement of the inner casing 41 and vane attachment points relative to the outer casing 40 and vane attachment points, relative axial movement in a rearward direction temporarily tilts the guide vane 23. The guide vane 23 consequently experiences both axial and radial displacement relative to the outer casing 40. Such axial and radial displacement results in pivotal movement of platforms 31 and 32, resulting in excessive leakage of hot gases and a reduction in overall performance of the engine 10 incorporating the described vane arrangement 23. This effect needs to be considered when designing the guide vane 23 and its location features, such that the guide vane 23 is in its optimum attitude at the main design point, which is usually taken to be a cruise condition. In this way, the guide vane 23 rotates anti-clockwise when experiencing rapid acceleration, resulting in reduced efficiency of the guide vane 23 and its associated seals. It will be appreciated that the guide vane 23 of FIG. 2 is shown in separation of one or more further guide vanes 23, which can be annularly arranged within the engine 10 to provide an annular array of guide vanes 23 defining an annulus about an axis of rotation. A single guide vane 23 arrangement is shown for reasons of clarity.

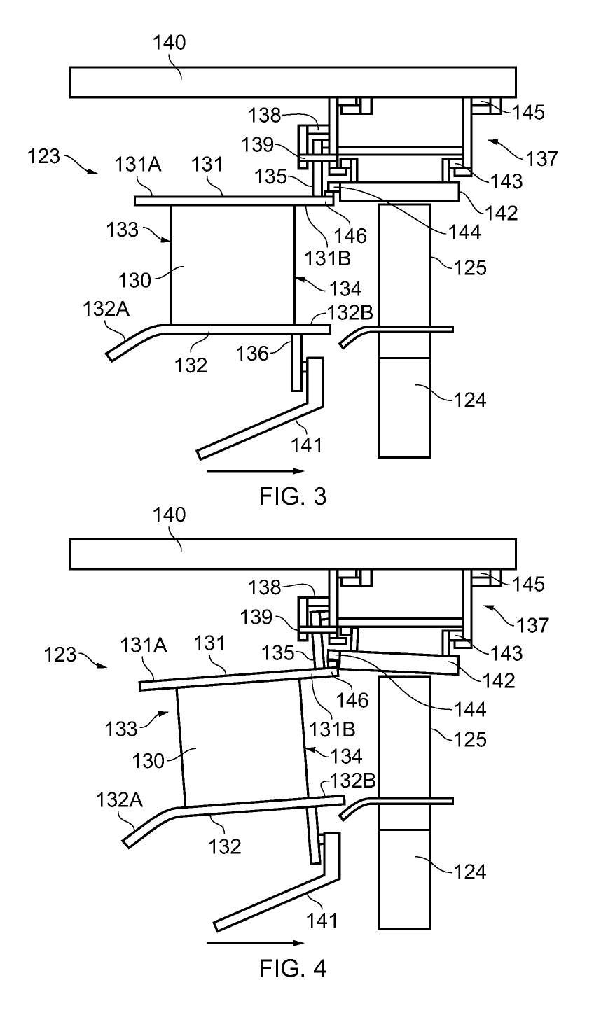

Referring to FIG. 3, there is shown a guide vane member 123 which is suitable for directing a working fluid onto a rotor blade 125. Such rotor blades 125 include those comprised within a compression stage, or a turbine stage of the high, intermediate and/or low pressure turbines 17, 18, 19 of the gas turbine engine 10. In the embodiment shown, the guide vane 123 is provided in the high pressure turbine 17 and will be associated with a casing as described later. It will be appreciated that the rotor blade 125 should not be limited to use in such stages and may be used in further such stages. The guide vane member 123 comprises an aerofoil 130 with an outer platform 131 and an inner platform 132. The outer platform 131 includes a platform portion 131A which extends forwards, i.e. upstream of a leading edge 133 of the vane aerofoil 130, and a platform portion 131B which extends rearwards, i.e. downstream of a trailing edge 134 of the vane aerofoil 130. The inner platform 132 includes a platform portion 132A which extends upstream of a leading edge 133 of the vane aerofoil 130, and a platform portion 132B which extends downstream of a trailing edge 134 of the vane aerofoil 130.

The guide vane member 123 is located radially outwardly of, and mounted to an inner casing 141 which defines an annulus within the gas turbine engine about an axis of rotation. The guide vane 123 is secured through one or more securing members 135 to a seal segment support assembly 137. The seal segment support assembly 137 is itself mounted to and located radially inwardly of an outer casing 140, which defines an annulus as part of the gas turbine engine 10 about an axis of rotation. The guide vane 123 shown is flexibly mounted to one or more of the outer and inner casing 140,141 to permit displacement in a predefined direction.

The function of the seal segment support assembly 137 is principally to support one or more seal segments 142 relative to the outer casing 140. Hence, the seal segment 142 is located radially inwardly of, and axially and/or radially constrained relative to the outer casing 140. In this way, the seal segment 142 is spaced from, and mounted to the outer casing 140 via the seal segment support 137. The seal segment support 137 supports one or more annularly configured seal segments 142 at a location radially outwardly of a blade 125 as part of a rotor and rotor disc 124 assembly (for example an HPT blade of a turbine stage), so defining a working gap therebetween. In this way, the working gap defines the degree of sealing provided by the particular seal segment relative to the blade 143.

As shown in FIG. 3, the or each seal segment 142 is slidably engaged with its corresponding seal segment support 137 to permit radial displacement of one or more portions of the or each seal segment 142 relative to its corresponding seal segment support 137. As shown in FIG. 3, this is permitted by one or more seal segment arms 143 which extend perpendicularly from the one or more seal segments 142 to slidably engage the seal segment support 137. Alternate means of slidable fixation may be alternatively envisaged.

As shown in FIG. 3, the seal segment further comprises one or more seal segment contact members 144 which axially extend from the upstream end of the seal segment 142, particularly from a portion of the seal segment 142 radially outwardly of a sealing face, towards the downstream end of the guide vane 123, the purpose of which will be later explained.

The one or more outer securing members 135 extend radially outwardly from platform portion 131B towards, and engage with the seal segment support assembly 137 in order to support the guide vane 123 relative to the outer casing 140 and provide ease of manufacture. Hence, the guide vane 123 is engaged with the seal segment support 137. Securing members 135 engage as indicated parts of the seal segment support assembly 137 to support the vane member 123 in use, relative to the outer casing 140. In this way, the seal segment support assembly 137 comprises a pivot arrangement 138 which allows each outer securing member 135 to be pivotably held relative to the outer casing 140 and/or the seal segment support assembly 137 itself. The pivotable arrangement of the outer securing member 135 to the seal segment support assembly 137 is provided by one or more attachment members 139 which extend perpendicularly from the one or more outer securing members 135 to engage the outer securing member 135 before securing against a further portion of the pivot arrangement 138. In this way, a spacing within or between the one or more attachment members 139 through which the outer securing member 135 extends is smaller than at least a portion of the outer securing member 135, so preventing withdrawal of the outer securing member 135 from a respective pivot arrangement 138 or the support assembly 137 itself. In this way, the outer securing member 135 need not be physically attached to the respective pivot arrangement 138 or the support assembly 137, but is held in position to prevent withdrawal, but allow rotation of the outer securing member 135 relative to the pivot arrangement 138 or the support assembly 137 itself.

It will be appreciated that many arrangements may be provided to pivotably hold securing members 135. Alternate means of temporary or permanent pivotable fixation may be alternatively envisaged, either to the pivot arrangement 138 or the support assembly 137 itself. Further such methods may include a permanent means of fixation of one or more outer securing members 135 to a respective pivot arrangement 138 or support assembly 137. Such a method relies on the flexual or resilient nature of the one or more outer securing members 135, or the shape and/or materials used in the construction of each outer securing member 135 to provide the required pivot action. Alternatively, outer securing members 135 can be fixed to a respective pivot arrangement 138 via one or more flexible or articulating couplings in order to provide the required pivot action.

The guide vane member 123 is further secured through one or more inner securing members 136, or via a further attachment assembly (not shown), to the radially inner casing 141. The one or more inner securing members 136 extend radially inwardly from platform portion 132B towards, and engage with the inner casing 141 in order to support the vane member 123 relative to the outer casing 140 and provide ease of manufacture. It will be understood that the securing members 136 engage as indicated parts of the vane member 123 to support the vane member 123 in use, relative to the inner casing 141. The vane member 123 may be rigidly attached to the inner casing 141, or the securing means may be alternatively flexably attached. In the arrangement shown, the guide vane 123 is flexibly mounted to the outer casing 140 and inner casing 141 to allow the guide vane 123 to pivot relative to the outer casing 140 upon axial displacement of the inner casing 141 relative to the outer casing 140.

The vane member 123 is shown to further comprise one or more vane contact members 146 which axially extend from the downstream end of the guide vane 123, the platform portion 131B which extending downstream of a trailing edge 134 of the vane aerofoil 130. In this way, at least a portion of the or each vane contact member 146 axially extends from the guide vane 123 radially outwardly of an aerofoil portion 130, or a radially outer portion of the guide vane 123 towards the seal segment 142. As shown, contact member 146 is arranged on platform portion 131B downstream of the securing member 135.

The or each vane contact member 146 is located and arranged relative to the or each seal segment contact member 144 such that the or each seal segment contact member 144 overlaps and is in contact with the or each vane contact member 146. In this way, both the seal segment contact member 144 and the guide vane contact member 146 are dimensioned to ensure that, over the entire range of normal operating movement of the inner casing relative to the outer casing 140, at least a portion of the seal segment contact member 144 which axially extends from the upstream end of the seal segment axially overlaps, and is slidably engaged with the guide vane contact member 146 which axially extends from the downstream end of the guide vane. In this way, when the engine 10 is at rest or at a cruise condition, or when the engine 10 is experiencing rapid acceleration such that the inner casing 141 is displaced relative to the outer casing 140, at least a portion of the seal segment contact member 144 axially overlaps, and is slidably engaged with the guide vane contact member 146.

Referring now to FIG. 4, the vane member 123 is pivotably engaged to the pivot arrangement 138 in order to pivot relative to one or more of the rotor blade 125, the seal segment 142, support assembly 137 or outer casing 140 upon relative movement between the inner 141 and outer casing 140. In this way, the vane member 123 is configured to pivot upon axial displacement of the inner casing 141 relative to one or more of the outer casing 140 and the rotor blade 125. In doing so, the guide vane 123 moves both axially and radially relative to the outer casing 140. Such axial and radial displacement results in anticlockwise pivotal rotation of platforms 131 and 132. Here, platform portions 131B and 132B, which extend downstream of a trailing edge 134 of the aerofoil 130, experiences at least a radially outward displacement relative to the inner casing 141. Conversely, platform portions 131A and 132A, which extend upstream of a leading edge 133 of the aerofoil 130, experiences at least a radially inward displacement relative to the inner casing 141.

Following the aforementioned pivoting of the vane member 123 during instances of deceleration, reduced power, or a reduced rate of change of power, the vane member 123 pivots back towards its original location, so moving both axially and radially relative to the outer casing 140. Such axial and radial displacement results in clockwise pivotal rotation of platforms 131 and 132. Here, the platform portions 131B and 132B, which extend downstream of a trailing edge 134 of the aerofoil 130, experiences at least a radially inward displacement relative to the inner casing 141. Conversely, platform portion 131A and 132A, which extend upstream of a leading edge 134 of the aerofoil 130, experiences at least a radially outward displacement relative to the inner casing 141.

Due to the pivotal arrangement described, wherein the or each seal segment contact member 144 overlaps and is in contact with the or each vane contact member 146, a radially outward displacement of the guide vane 123 relative to the outer casing 140 also results in a radially outward displacement of at least a portion of the or each seal segment 142 relative to one or more of the blade 125 and the outer casing 140. Additionally or alternatively, the seal segment 142 can be configured to pivot upon a radially outward displacement of the guide vane 123. In this way, a radial and/or axial displacement of the or each contact member 144 relative to the rotor blade 143, at least partially increases the working gap therebetween.

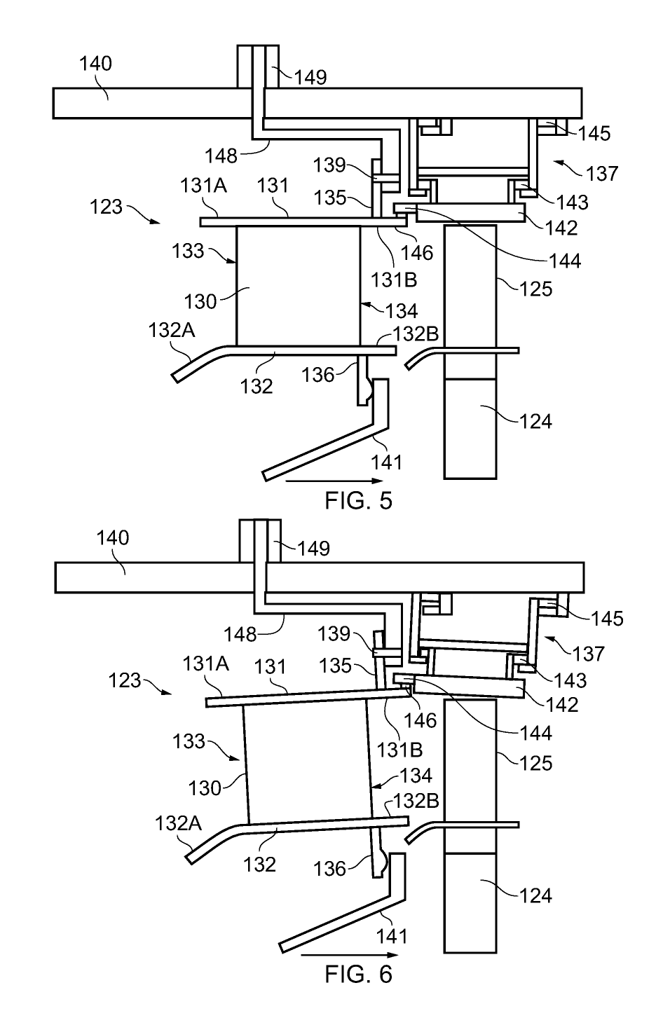

Referring now to FIG. 5, the vane member 123 can alternatively be secured through one or more securing members 135 to one or more further support members 148 via one or more attachment members 139. Here, the one or more further support members 148 are secured to the outer casing 140, so securing the vane member 123 to the outer casing 140. As such, the guide vane 123 is engaged with one or more support members 148, the or each support member 148 being engaged with the outer casing 140. The further support member can optionally extend through the casing 140 for subsequent securing to the casing using an external attachment member 149, so increasing the resilience and/or strength of the second support member 148.

The function of the one or more further support members 148 and external attachment member 149 is principally to support one or more vane members 123 relative to the outer casing. Hence, both the seal segment 142 and vane member 123 are located radially inwardly of, and axially and/or radially constrained relative to the outer casing 140. In this way, both the seal segment 142 and vane member 123 are spaced from, and mounted to the outer casing 140 via the seal segment support 137. The vane member 123 support and the seal segment 142 support are separated, so providing an alternate arrangement to that shown in FIGS. 3 and 4. In this way, the seal segment support 137 supports one or more annularly configured seal segments 142 at a location radially outwardly of a blade 143 as part of a rotor or rotor disc 124 assembly (for example an HPT blade of a turbine stage), so defining a working gap therebetween. In this way, the working gap defines the degree of sealing provided by the particular seal segment relative to the blade 143.

As shown in FIG. 5, the or each seal segment 142 is slidably engaged relative to its corresponding seal segment support 137 to permit radial displacement of one or more portions of the or each seal segment 142 relative to its corresponding seal segment support 137. As shown in FIG. 5, this is permitted by one or more seal segment arms 143 which extend perpendicularly from the one or more seal segments 142 to slidably engage the seal segment support 137. Alternate means of slidable fixation may be alternatively envisaged, the purpose of which is to allow free radial movement of the seal segment 142 relative to one or more of the seal segment support 137 and the outer casing 140.

Additionally or alternatively, the seal segment support 137 is slidably engaged relative to the outer casing 140 to permit radial displacement of one or more portions of the or each seal segment 142 and/or seal segment support 137 relative to the casing 140. As shown in FIG. 5, this is permitted by one or more connection members 145 which extend from the casing 140 to engage the seal segment support 137. The connection members 145 slidably engage the seal segment support 137 and provide a means of fixation to the casing 140. Alternate means of slidable or rotatable fixation may be alternatively envisaged. In this way, the or each segment support 137 and/or seal segment 142 is slidably or pivotably engaged relative to the outer casing to permit radial displacement of the or each seal segment 142 and/or segment support 137 relative to the outer casing 140. It will nevertheless be appreciated that in such examples, the seal segment 142 is engaged with the seal segment support 137, the seal segment support 137 being engaged with the outer casing 140.

The one or more outer securing members 135 extend radially outwardly from platform portion 131B towards, and engage with the seal segment support assembly 137 in order to support the guide vane 123 relative to the outer casing 140 and provide ease of manufacture. Securing members 135 engage as indicated parts of the further support members 148 to support the vane member 123 in use, relative to the outer casing 140. In this way, the one or more further support members 148 are deflectable relative to the outer casing 140. This allows the one or more outer securing members 135 as part of the guide vane 123 to be pivotably held relative to the outer casing 140 and/or the seal segment support assembly 137 itself, the pivotable movement being provided by the deflective shape and/or resilient nature of the materials used in the construction of the further support members 148. In this way, the further support members 148 include one or more deflections within the general shape of the further support members 148 to induce a deflection of the further support members 148 upon application of a directional force. Materials used in the construction of the further support member 148 may include high-strength metallic materials such as steel, nickel and nickel-based superalloy materials, capable of high temperature creep and deformation resistance, whilst providing sufficient resilience to resist deformation other than when required.

It will also be appreciated that many such arrangements may be provided to secure the one or more outer securing members 135 as part of the guide vane 123 to the further support members 148. One such method may include one or more attachment members 139 which project from the one or more outer securing members 135 to engage the further support members 148. Alternate means of temporary or permanent pivotable fixation may be alternatively envisaged. Further such methods may include a permanent means of fixation whilst relying on the flexual nature of the further support members 148 to provide the required pivoting action. Alternatively, outer securing members 135 can be fixed to a respective pivot arrangement 138 via one or more flexible or articulating couplings in order to provide the required pivot action. In this way, the one or more attachment members 139 allow the outer securing members 135 to pivot relative to the further support members 48 via a flexible or articulating coupling.

Using such an arrangement requires a member of sufficient stiffness to resist deflection upon application of a directional force. Alternate means of temporary or permanent pivotable fixation may be alternatively envisaged. Further such methods may include a permanent means of fixation whilst relying on the flexual nature of the one or more outer securing members 135 to provide the required pivoting action. Additionally or alternatively, further means of pivotable coupling may be used to secure the outer securing members 135 to the further support members 148.

The guide vane member 123 is further secured through one or more inner securing members 136, or via a further attachment assembly (not shown), to the radially inner casing 141. The one or more inner securing members 136 extend radially inwardly from platform portion 132B towards, and engage with the inner casing 141 in order to support the vane member 123 relative to the outer casing 140 and provide ease of manufacture. It will be understood that the securing members 136 engage as indicated parts of the vane member 123 to support the vane member 123 in use, relative to the inner casing 141. The vane member 123 may be rigidly attached to the inner casing 141, or the securing means may be alternatively flexibly attached. The guide vane 123 shown is flexibly mounted to one or more of the outer and inner casing 140,141 to permit displacement in a predefined direction. In this way, the guide vane 123 is flexibly mounted to the outer casing 140 and inner casing 141 to allow the guide vane 123 to pivot relative to the outer casing 140 upon axial displacement of the inner casing 141 relative to the outer casing 140.

The vane member 123 is shown to further comprise one or more vane contact members 146 which axially extend from the downstream end of the guide vane 123 and in particular the platform portion 131B which extends rearwards of a trailing edge 134 of the vane aerofoil 130. In this way, at least a portion of the or each vane contact member 146 axially extends from the guide vane 123 radially outwardly of an aerofoil portion 130, or a radially outer portion of the guide vane 123 towards the seal segment 142.

The or each vane contact member 146 is radially arranged relative to the or each seal segment contact members 144 such that the or each seal segment contact members 144 overlap and are in contact with the or each vane contact member 146. In this way, both the seal segment contact member 144 and the guide vane contact member 146 are sufficiently dimensioned to ensure that, over the entire range of movement of the inner casing relative to the outer casing 140, at least a portion of the seal segment contact member 144 axially and radially overlaps, and is slidably engaged with the guide vane contact member 146. As such, when the engine 10 is at rest or at a cruise condition, or when the engine 10 is experiencing rapid acceleration such that the inner casing 141 is displaced relative to the outer casing 140, at least a portion of the seal segment contact member 144 continually overlaps, and is slidably engaged with the guide vane contact member 146.

Referring now to FIG. 6, the vane member 123 is pivotably engaged to and pivotable about the one or more attachment members 139 or a flexual position of the further support members 148 upon axial displacement of the inner casing 141 relative to the outer casing 140. In this way, the vane member 123 pivots upon axial displacement of the inner casing 141 relative to the outer casing 140. In doing so, the guide vane 123 moves both axially and radially relative to the outer casing 140. Such axial and radial displacement results in anticlockwise pivotal rotation of platforms 131 and 132. Here, platform portions 131B and 132B, which extend downstream of a trailing edge 134 of the aerofoil 130, experiences at least a radially outward displacement relative to the inner casing 141. Conversely, platform portions 131A and 132A, which extend upstream of a leading edge 133 of the aerofoil 130, experiences at least a radially inward displacement relative to the inner casing 141.

Following the aforementioned pivoting of the vane member 123 during one or more instances of deceleration, reduced power, or a reduced rate of change of power produced by the gas turbine engine, the inner casing moves axially upstream of the gas turbine engine. This results in differential axial movement of the inner casing 141 relative to the outer casing 140. In doing so, the vane member 123 pivots back towards its original location, so moving both axially and radially relative to the outer casing 140. Such axial and radial displacement results in clockwise pivotal rotation of platforms 131 and 132. Here, the platform portions 131B and 132B, which extend downstream of a trailing edge 134 of the aerofoil 130, experiences at least a radially inward displacement relative to the inner casing 141. Conversely, platform portion 131A and 132A, which extend upstream of a leading edge 134 of the aerofoil 130, experiences at least a radially outward displacement relative to the inner casing 141.

Due to the pivotal arrangement described, wherein the or each seal segment contact member 144 overlaps and is in contact with the or each vane contact member 146, a radially outward displacement of the guide vane 123 relative to the outer casing 140 also results in a radially outward displacement of at least a portion of the or each seal segment 142 and/or the seal segment support 137 relative to one or more of the blade 125 and the outer casing 140. Additionally or alternatively, the seal segment 142 can be configured to pivot upon a radially outward displacement of the guide vane 123. In this way, a radial and/or axial displacement of the or each contact member 144 relative to the rotor blade 143, at least partially increases the working gap therebetween.

It will be understood that the invention is not limited to the embodiments above-described and various modifications and improvements can be made without departing from the concepts described herein. Except where mutually exclusive, any of the features may be employed separately or in combination with any other features and the disclosure extends to and includes all combinations and sub-combinations of one or more features described herein.

What is claimed is:

1. A gas turbine engine for the provision of propulsive thrust, comprising a rotor blade, an inner casing and an outer casing, the gas turbine engine further comprising;
a guide vane, located upstream of the rotor blade and between the inner and outer casing, the guide vane comprising a vane contact member, wherein the guide vane is configured to pivot upon axial displacement of the inner casing relative to either or both of the outer casing and the rotor blade; and,
a seal segment located radially outwardly of the rotor blade and mounted for radial displacement relative to the rotor blade;
wherein at least a portion of the seal segment axially overlaps, and slidably engages a downstream end of the guide vane so that in use, a pivoting of the guide vane causes the vane contact member to undergo a radially outward displacement, the radially outward displacement of the vane contact member causing a radially outward displacement of at least a portion of the seal segment.

2. A gas turbine engine as claimed in claim 1, wherein the guide vane is located radially inwardly of, and flexibly mounted to the outer casing.

3. A gas turbine engine as claimed in claim 1, wherein the guide vane may be located radially outwardly of, and flexibly mounted to the inner casing.

4. A gas turbine engine as claimed claim 1, wherein the guide vane comprises one or more vane contact members which axially extend from a portion of the guide vane, the contact member extending radially outwardly of an aerofoil portion.

5. A gas turbine engine as claimed in claim 1, wherein the seal segment comprises one or more seal segment contact members which axially extend from a portion of the seal segment, the one or more seal segment contact members extending radially outwardly of a sealing face of the seal segment.

6. A gas turbine engine as claimed claim 1, wherein the seal segment is located radially inwardly of, and is either or both of axially and circumferentially constrained relative to the outer casing.

7. A gas turbine engine as claimed in claim 1, wherein the seal segment is spaced from, and mounted to the outer casing via a seal segment support.

8. A gas turbine engine as claimed in claim 7, wherein the guide vane is flexibly mounted to the seal segment support to allow the guide vane to pivot relative to the outer casing upon axial displacement of the inner casing relative to the outer casing.

9. A gas turbine engine as claimed in any of claim 7, wherein the seal segment is slidably engaged with the seal segment support to permit radial displacement of one or more portions of the seal segment relative to the seal segment support.

10. A gas turbine engine as claimed in claim 7, wherein the seal segment support is slidably engaged with the outer casing to permit radial displacement of one or more portions of the seal segment support relative to the outer casing.

11. A gas turbine engine as claimed in claim 1, wherein the guide vane is flexibly mounted to the outer casing and inner casing to allow the guide vane to pivot relative to the outer casing upon axial displacement of the inner casing relative to the outer casing.
